(19) United States
(12) Patent Application Publication
(10) Pub. No.: US 2015/0310465 A1
(43) Pub. Date: Oct. 29, 2015

(54) BEHAVIORAL DEMAND RESPONSE RANKING

(71) Applicant: Opower, Inc., Arlington, VA (US)

(72) Inventors: Jonathan Chan, Alamo, CA (US); Alexandra Liptsey-Rahe, San Francisco, CA (US); Ryan Devenish, San Francisco, CA (US); James Jones, San Francisco, CA (US)

(21) Appl. No.: 14/458,143

(22) Filed: Aug. 12, 2014

Related U.S. Application Data
(60) Provisional application No. 61/984,566, filed on Apr. 25, 2014.

(51) Int. Cl. G06Q 30/02

(52) U.S. Cl. CPC G06Q 30/0205

(57) ABSTRACT

A behavioral demand response (BDR) system can be implemented to encourage reductions in resource consumption. To accomplish this, consumption reports detailing resource consumption can be generated and transmitted to consumers to encourage resource consumption. For example, a resource consumption report can be generated and transmitted to consumers prior to an identified peak resource consumption event or “peak event” to notify the consumers of the upcoming peak event and request that the consumer reduce resource consumption before/during the peak event. To encourage the consumer to reduce their resource consumption, the resource consumption report can include details regarding the consumer's resource consumption ranking relative to similarly situated consumers.

### CROSS REFERENCE TO RELATED APPLICATIONS

This application claims priority to U.S. provisional application No. 61/984,566, entitled “BEHAVIORAL DEMAND RESPONSE RANKED DESIGN,” filed on Apr. 25, 2014, which is expressly incorporated by reference herein in its entirety.

### BACKGROUND

Peak resource consumption events or “peak events” can happen multiple times per year for any given resource, such as electricity, gas, water, internet, bandwidth, etc. For example, peak events for electricity, gas, water, and/or etc. usually occur during the summer months due to hot weather and consequently, heavy air conditioning loads. During peak periods, the wholesale price of electricity increases due to the need to fire up stand-by electric generation plants. Typically, such events fall in the afternoon on summer weekdays. During these peak events, resource providers may rely on automated solutions (e.g., switches) to reduce demand load. Alternatively, some utilities rely on financial incentives to reduce demand during peak periods, examples of such incentives include punitive pricing (e.g., critical peak pricing), and/or rebates (e.g., peak time rebates).

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example configuration of devices and a network in accordance with various aspects of the technology;

FIG. 2 illustrates an example resource consumption report that can be transmitted during or after a BDR campaign has been initiated, according to some aspects of the technology;

FIG. 3 illustrates another example resource consumption report, according to some aspects of the technology;

FIG. 4 illustrates another example resource consumption report, according to some aspects of the technology;

FIG. 5 illustrates an example resource consumption report that notifies a consumer of an upcoming peak event, according to some aspects of the technology;

FIG. 6 illustrates an example resource consumption report that includes ranking data, according to some aspects of the technology;

FIG. 7 illustrates an example method for implementing a BDM program to reduce resource consumption, according to some aspects of the technology; and

FIGS. 8A and 8B illustrate example system embodiments that can be used to implement certain aspects of the subject technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for enabling a Behavioral Demand Response (BDR) system to reduce resource consumption. A BDR system can be implemented to encourage reductions in resource consumption. To accomplish this, consumption reports detailing resource consumption can be generated and transmitted to consumers to encourage the consumers to reduce their resource consumption. For example, a resource consumption report can be generated and transmitted to consumers prior to an identified peak resource consumption event or “peak event” to notify the consumers of the upcoming peak event and request that the consumer reduce their resource consumption before/during the peak event.

To encourage the consumer to reduce their resource consumption, the resource consumption report can include details about increased peak pricing or rebates offered for reducing resource consumption. In certain aspects, the report can also include comparative data that indicates the consumer's/user's resource consumption (or progress in consumption reduction) relative to one or more similar users. As discussed in further detail below, comparative indications can provide a particular user with ranking information, which shows the user's performance as ranked against others.

In some aspects, the resource consumption report transmitted to a consumer can include data that shows the consumer's progress over time. For example, the resource consumption report can include data tracking the consumer's progress towards reaching a resource reduction goal, such as reducing resource consumption to a specified target consumption amount. Alternatively, the resource consumption report can include data indicating the consumer's improvement in reducing resource consumption from a previous monitoring period (e.g., a target reduction amount, a target reduction percentage, etc.).

In some aspects, a consumer's resource consumption can be compared to the resource consumption of other consumers. For example, the consumer can be ranked amongst a subset of similar consumers or all other consumers based on resource consumption. Similarities between users can be differently defined, depending on implementation.

In certain aspects, comparisons may only be made between different users that reside within a common geographic region, such as a neighborhood, city or zip code. In some implementations, user demographic information may be used, for example user demographic information may include on or more of: residence type, ownership status, dwelling square footage, new mover status, solar installation information and/or dwelling square footage, etc.

The resource consumption report transmitted to a consumer can indicate the consumer's rank as well as the consumer's progress (change) in the rankings from a previous monitoring period. This can provide the consumer with additional motivation to continue reducing resource consumption.

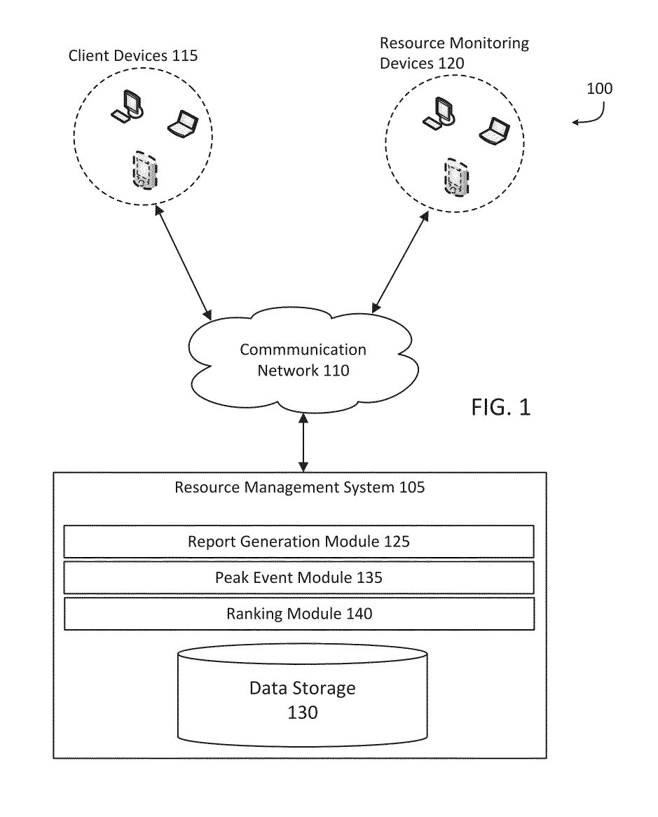

FIG. 1 illustrates an exemplary system configuration 100, wherein electronic devices communicate via a network for purposes of exchanging content and other data. As illustrated, multiple computing devices (client devices 115, resource monitoring devices 120 and resource management system 105) can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communications links associated with one or more service providers, including one or more wired communication links, one or more wireless communication links, or any combination thereof. Additionally, communication network 110 can be configured to support the transmission of data formatted using any number of protocols.

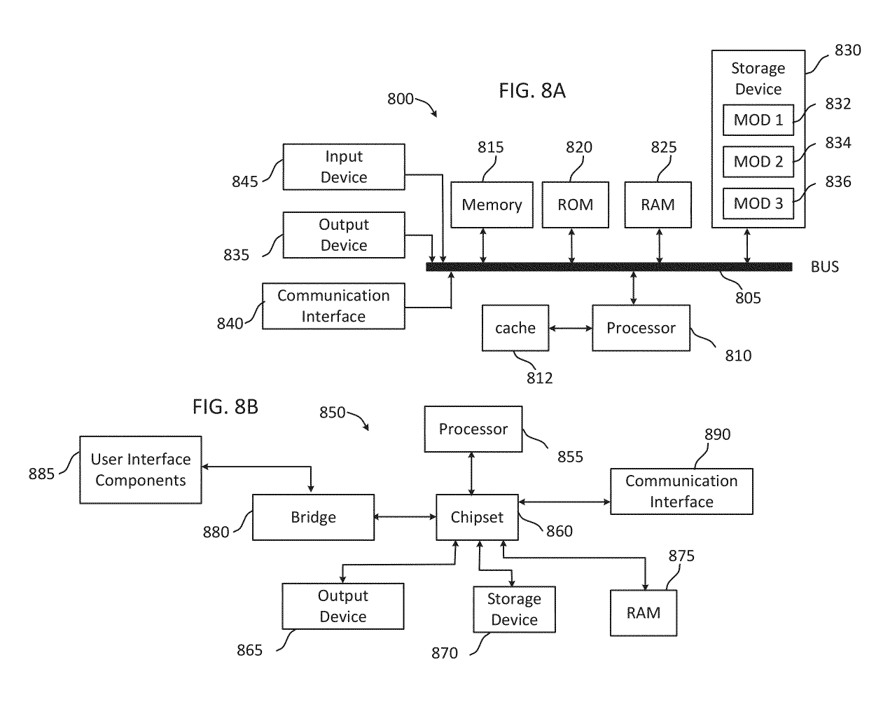

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 800 of FIGS. 8A and 8B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

Resource management system 105 can be configured to generate resource consumption reports and transmit the resource consumption reports to consumers to encourage resource reductions. It is understood that a resource can be any type of consumable resource. For example, a resource can be a natural resource such as water, gas, oil, electricity, coal, etc. Alternatively, a resource can be a digital resource such as bandwidth, data storage, computing power, etc. Further, a resource can be raw materials, labor, finished goods, machinery, recyclables, etc.

A consumer/user can be any person, group of people, building or premises, entity, etc., that consumes resources. For example, a consumer can be an individual, a family, a household, business, etc.

A resource consumption report can be any type of report or message that details or describes resource consumption. For example, a resource consumption report can be a report detailing past resource consumption of individual consumers and/or multiple consumers. Alternatively or additionally, a resource consumption report can detail expected future resource consumption of an individual and/or multiple consumers. For example, a resource consumption report can identify predicted peak resource consumption events or “peak events,” during which an increase in resource consumption is expected.

In addition to describing resource consumption, a resource consumption report can also include a message encouraging a consumer to reduce their resource consumption. For example, a resource consumption report that includes details of an upcoming peak event can also include a message encouraging a consumer to reduce their resource consumption during the expected peak event. For example, the resource consumption report can include details of monetary savings or rebates associated with reducing resource usage during a defined time frame, such as during the predicted peak event.

Resource management system 105 can be configured to receive resource consumption data from one or more resource monitoring devices 120 in network communication with resource management system 105. Resource consumption data can be any information describing resource consumption by one or more consumers. For example, resource consumption data can describe an amount of resources consumed, a rate of resource consumption over a predefined time period, a type of resources consumed, information related to one or more consumer/s that consumed the resources, times in which the resource/s were consumed, geographic location/s at which the resources were consumed, etc.

A resource monitoring device 120 can be any type of device that can monitor resource consumption and/or receive resource consumption data. For example, a resource monitoring device can be a utility monitoring device, such as a gas/electricity meter attached to a building to monitor the gas and electricity consumed at a building's location. Alternatively, a resource monitoring device can be a computing device in which resource consumption data is entered or received from metering devices. For example, resource monitoring device 120 can be a utility company server that gathers or receives resource consumption data from a plurality of consumers.

Resource management system 105 can include data storage 130 configured to store resource consumption data and resource management system 105 can be configured to store the received consumption data in data storage 130. Data storage 130 can also store consumer profile data for multiple consumers. This can include each consumer's name, address, contact info, location, types of resources consumed, etc. The consumer profile data stored in data storage 130 can be associated with the resource consumption data for the specified consumer.

Resource management system 105 can also include report generation module 125 that is configured to generate resource consumption reports that can be transmitted to consumers to encourage the consumers to reduce their resource consumption. Report generation module 125 can be configured to communicate with data storage 130 and/or one or more resource monitoring devices 120 to retrieve resource consumption data and generate the resource consumption reports. Report generation module 125 can then transmit the generated resource consumption reports to the appropriate consumers.

Report generation module 125 can transmit the generated resource consumption reports in a variety of ways. For example, in some embodiments, report generation module 125 can transmit the resource consumption reports as text or an instant message that is received on the consumer's client device 115. Alternatively, report generation module 125 can transmit the resource consumption reports in an e-mail to the appropriate consumers. Further, report generation module 125 can transmit the generated resource consumption report as a short message service (SMS), interactive voice response (IVR), traditional mail, etc. Report generation module 125 can communicate with data storage 130 to gather contact information for the consumers which can then be used to transmit the resource consumption reports.

According to some aspects, the generated resource consumption reports may be provided to consumers via a website hosted by resource management system 105. For example, a consumer may login to a secure website and view their corresponding resource consumption report. In some implementations a link to the website may be transmitted to the consumer via any of the variety of ways discussed above.

In some embodiments, report generation module 125 can transmit the resource consumption reports to consumers via one or more preferred communication channels selected by the consumer. For example, resource management system 105 can be configured to provide a resource consumption interface that enables consumers to select one or more preferred communication channels through which the consumer would like to receive resource consumption reports. Consumers can use one of client devices 115 to communicate with resource management system 105 to access the resource consumption interface and select their preferred communication channel. Content management system 105 can store the preferred communication channel in data storage 130 and associate the stored data with the corresponding consumer. Report generation module 125 can communicate with data storage 130 to gather the preferred communication channel selected by a consumer, which can then be used to determine the communication channel with which to transmit the resource consumption report to the consumer.

In some embodiments, report generation module 125 can be configured to generate and transmit resource consumption reports to consumers at predetermined times or according to a predetermined schedule. For example, report generation module 125 can be configured to generate and transmit resource consumption reports once a day, week, month, season etc.

In some embodiments, report generation module 125 can be configured to generate and transmit resource consumption reports to consumers in response to the detection of a particular event. For example, the report generation module 125 may determine an expected peak event is scheduled, generate a resource consumption report for a consumer in response to the detection of the expected peak event, and transmit the resource consumption report prior to the expected peak event. This can include known recurring peak events, for example, based on historical data, as well as determined and/or predicted peak events. For example, report generation module 125 can have access to a schedule of recurring peak events and be configured to generate and transmit resource consumption reports prior to the recurring peak events.

Alternatively, report generation module 125 can be configured to receive data describing an upcoming peak event. For example, an administrator of resource management system 105 can login and enter details of an upcoming peak event. Alternatively, resource management system 105 can receive details of an upcoming peak event from a resource provider, such as a utility company. The resource provider can transmit data detailing the peak event to resource management system 105 or, alternatively, resource management system 105 can periodically query the resource provider regarding whether a peak event is upcoming. Report generation module 125 can be configured to generate and transmit resource consumption reports prior to the upcoming peak event.

In certain implementations, resource management system 105 can be configured to predict upcoming peak events. Resource management system 105 can include peak event module 135 configured to analyze data to predict upcoming peak events. For example, peak event module 135 can be configured to communicate with data storage 130 or resource monitoring devices 120 (e.g., utility servers) to access resource consumption data. The peak event module 135 can analyze the retrieved data to predict upcoming peak events. For example, peak event module 135 can analyze the resource consumption data to identify trends of factors that indicate that a peak event is upcoming. This can include analyzing a peak event for a specified resource type, geographic region, consumer group, etc.

In some implementations, peak event module 135 can be configured to receive and analyze non-consumption data to predict an upcoming peak event. Non-consumption data can be any type of data that is not resource consumption data. For example, peak event module 135 can analyze environmental data, such as the weather forecast (e.g., weather forecast data), to predict resource consumption. Hot weather and/or cold weather can indicate an increase in the consumption of certain resources, such as water, electricity and/or gas. As such, peak event module 135 can use information relating to weather conditions as a factor in predicting an upcoming peak event. For example, peak event module 135 can determine that a peak event is likely on a specified day if the predicted weather for that day is above and/or below a specified threshold value.

In some embodiments, the threshold value can be based on historical resource consumption data and weather data. For example, peak event module 135 can be configured to analyze historical resource consumption data and historical weather data to identify the temperature during previous peak events. Peak event module 135 can further calculate one or more threshold values that, if the weather is predicted to be higher or lower, indicate a likely peak event.

Furthermore, resource management system 105 can receive non-consumption data from one or more 3^{rd} party servers (not illustrated) in network connection with resource management system. For example, a 3^{rd} party server can provide environmental data, such as the historical weather data, current weather data, and predicted weather forecast, to resource management system 105.

Peak event module 135 can be configured to transmit a notification to report generation module 125 upon predicting an upcoming peak event. The notification can include data describing the predicted peak event, including the predicted times, resources consumed, etc. In response, report generation module 125 can generate a resource consumption report including details of the predicted peak event as well as a message encouraging consumers to reduce their resource consumption. Report generation module 125 can transmit the generated resource consumption report to the consumers prior to the predicted peak event.

To encourage consumers to reduce resource consumption, the resource consumption reports generated for a consumer can include details regarding monetary savings and/or rebates that can be earned by reducing resource consumption. For example, a resource consumption report can include an anticipated monetary cost for a consumer if the consumer does not reduce their resource consumption, as well as an anticipated monetary cost if the consumer does reduce their resource consumption. Report generation module 125 can calculate the anticipated monetary cost based on the consumer's past resource consumption data. The consumer can then easily view the money that would be saved by reducing resource consumption.

In some embodiments, the consumers can be compared to other consumers to further motivate the consumers to reduce resource consumption. For example, resource management system 105 can rank the consumers based on their resource consumption and generate resource consumption reports for a consumer that includes data describing the consumer's determined rank. This can include the consumer's rank amongst all other consumers, other consumers participating in a demand response program, and/or the consumer's rank amongst a subset of similar consumers.

To accomplish this, resource management system 105 can include ranking module 140 configured to rank consumers based on resource consumption. Ranking module 140 can be configured to communicate with data storage 130 and/or other information sources to access resource consumption data for the consumers and generate ranking data for the consumers from the resource consumption data. The ranking data for a consumer can indicate the consumers rank in relation to other consumers based on resource consumption. Ranking module 140 can store the generated ranking data in data storage 130 where it can be associated with the corresponding consumer. Report generation module 125 can access the ranking data for a consumer from data storage 130 and generate a resource consumption report for a consumer based on the consumer's ranking data.

In some embodiments, ranking module 140 can rank a consumer based on the consumer's resource consumption versus all other consumers. The generated ranking data would thus indicate the consumer's overall rank amongst all other consumers. In certain aspects, ranking module 140 can also be configured to rank a consumer based on the consumer's resource consumption amongst a subset of consumers. For example, ranking module 140 can be configured to rank a consumer with other similar consumers, such as those sharing common demographic similarities, those within a specified geographic region, and/or consumers of similar size, etc.

In some embodiments, ranking module 140 can be configured to determine that a group of consumers are similar and rank the consumers in the group amongst each other. Ranking module 140 can determine that a group of consumers are similar based on multiple factors. One possible factor can be geographic location of the consumer. Consumers can be determined to be more similar if they are located in close geographic proximity and less similar if they are located farther from each other geographically. Another factor can be the location type of the consumers. For example, consumers from a similar type of location, such as from suburban, rural or urban areas, can be considered to be similar even if they are geographically disparate, whereas consumers from a different type of location can be determined to be less similar, even if they are geographically proximate.

Another factor in determining that a group of consumers is similar can be the size of the individual consumers. Consumers, such as families, can be compared based on the size of the family (i.e. number of members of the family living together). Likewise, consumers such as a company can be compared based on the size of the company (i.e. number of employees). Consumers can be determined to be more similar if they are of similar size, and less similar if they are of differing sizes.

Consumer size can also include the size of a building or dwelling size/dwelling type associated with the consumer. For example, consumers such as families can be considered similar if they occupy similarly sized homes (e.g. similar dwelling size). Similarly, consumers may be considered to be similar if they all live in the same type of residence (e.g., single family homes, apartments, high-rise condominiums, etc., (e.g., similar dwelling type). Likewise, consumers such as companies can be considered similar if they have similar size office space.

In some embodiments, a group of consumers can be determined to be similar based on their historical resource consumption. For example, consumers that consume a similar amount of resources on average for a given time period can be determined to be more similar.

Although ranking consumers is described above as being based on resource consumption, this is only one possible embodiment and is not meant to be limiting. In some embodiments, the consumers can be ranked based on the monetary amount the consumers have saved or earned by reducing their resource consumption. In some aspects, consumers can be ranked based on their improvement from a previous time period. For example, consumers can be ranked based on resource consumption reduction, as measured from a baseline resource usage, calculated either on a consumer-by-consumer (or consumer-group by consumer-group) basis. Thus the consumers can be ranked on the amount which each consumer reduced their resource consumption from their specific baseline resource consumption.

Alternatively, the consumers can be ranked based on their resource consumption during a specified period of time, such as during a peak event or during a number of peak events. The consumers can be ranked based on their resource consumption during the peak event, as well as their improvement during one or more previous peak events.

In some aspects, report generation module 125 can be configured to generate a resource consumption report for a consumer that will best encourage the consumer and/or not discourage the consumer from continuing to reduce resource consumption. For example, report generation module 125 can be configured to select the resource consumption data to include in the resource consumption report for a consumer based on ranking data for the consumer.

To encourage a consumer to continue to reducing their resource consumption, the consumer can be presented with data that highlights the consumer's achievements. For example, if a consumer ranks highly amongst a group of similar consumers to which the consumer has been compared, report generation module 125 can be configured to select to include and/or highlight the consumer's high ranking amongst the group of similar consumers.

Likewise, to avoid discouraging a consumer from continuing to reduce resource consumption, the consumer can be presented with data that marginalizes the consumer's poor ranking in relation to other consumers. For example, if a consumer ranks poorly amongst a group of similar consumers, report generation module 125 can be configured to omit the ranking data indicating the consumer's poor performance form the resource consumption report. Report generation module 125 can also replace the ranking data with alternate ranking data that may not reflect that the consumer performed as poorly. For example, a consumer that ranked poorly amongst a group of similar consumers may have ranked better when compared to the pool of consumers as a whole. In this situation, report generation module 125 can select to present the consumer's ranking data in relation to the consumers as a whole rather than the consumer's ranking data in relation to the group of similar consumers.

In some embodiments, report generation module 125 may include the most favorable ranking data in a resource consumption report for a consumer. For example, a consumer can be ranked based on multiple metrics, such as resource consumption, improvement (e.g., improvement in the level of consumption reduction), etc., and report generation module 125 can select to include the ranking data that reflects the consumer's best ranking. Thus, if a consumer was not ranked in a top predetermined percentage group, such as the top 25%, based on resources consumed, but the consumer was ranked in the top 25% as measured by improvement over a previous time period, report generation module 125 can select to present the ranking data for improvement in the consumer's resource consumption report, thereby highlighting the consumer's accomplishments and further encouraging the consumer to continue reducing resource consumption.

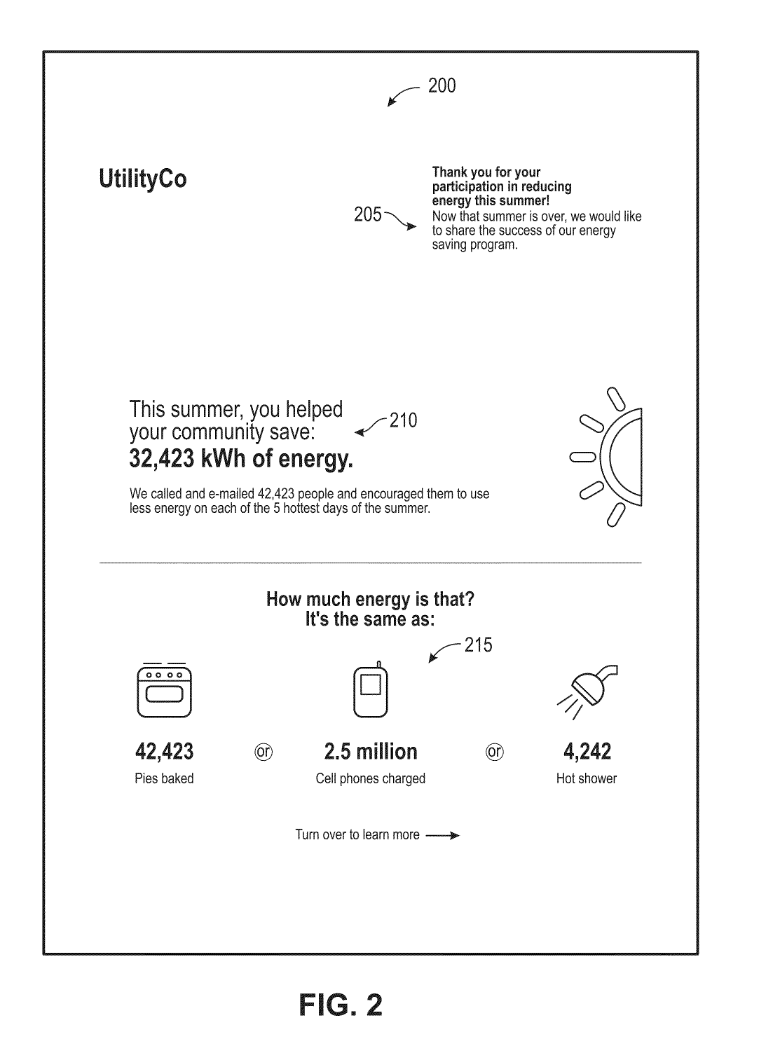

FIG. 2 illustrates an example resource consumption report 200 that can be transmitted during or after a BDR campaign has been initiated. As shown, resource consumption report 200 can include message 205 thanking the consumer for participating in the resource consumption program. Thanking the consumer for their participation can further encourage the consumer to reduce resource consumption.

Resource consumption report 200 can also include resource consumption data 210 that describes the resource consumption by the consumer. As shown, resource consumption data 210 describes resource consumption of a population of consumer living in a specified community or geographic location. Further, resource consumption data 210 describes the amount of resource consumption that was reduced by the population of consumers. Providing this type of large scale data that reflects the impact of the BDR campaign can further encourage consumers to participate in the future and reduce resource consumption.

Resource consumption report 200 can also include analogy data 215 that provides an analogy for resource consumption data 210 that further illustrates the impact of the consumer's reduction in resource consumption. As shown, analogy data 215 describes the impact of the resource reduction in terms of the number of ordinary tasks that can be performed with the saved resources, such as the number of pies that can be baked, cell phones that can be charged and/or hot showers that can be taken.

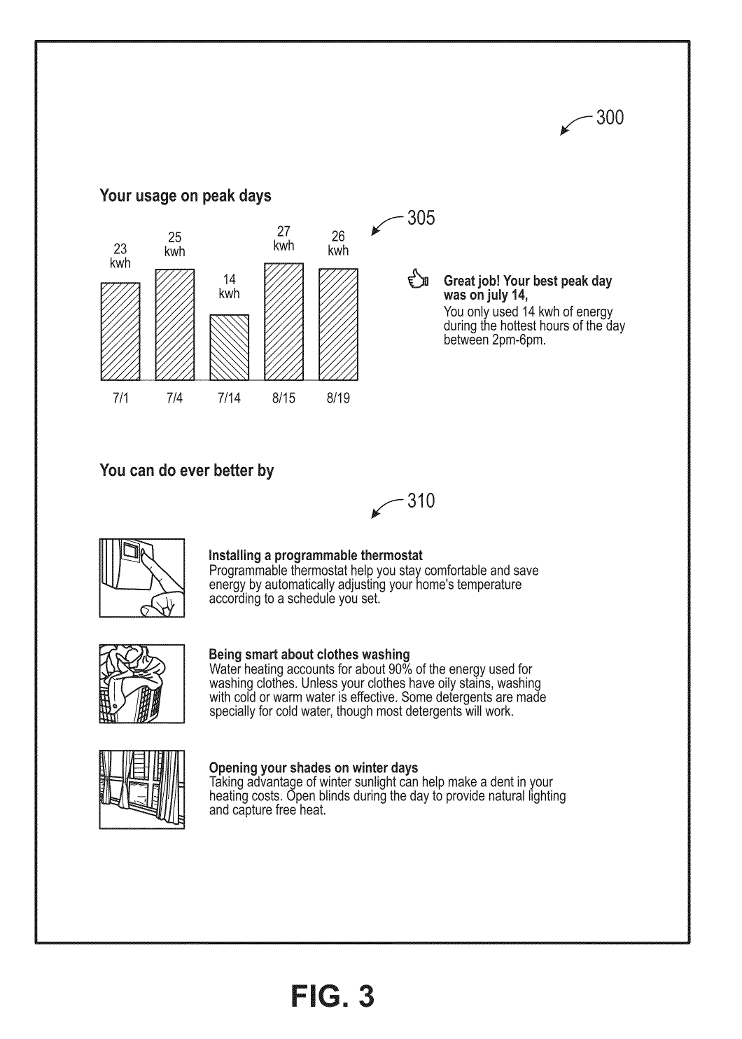

FIG. 3 illustrates another exemplary resource consumption report 300. As shown, resource consumption report 300 includes resource consumption data 305 that details the specific consumer's resource consumption. As shown, resource consumption data 305 charts the consumer's resource consumption during peak events. Further resource consumption data 305 also includes a message highlighting the consumer's best performance during a peak event as well as a message of congratulations for doing such a great job.

Resource consumption report 300 further includes recommendations 310 that detail further steps that can be taken by the consumer to continue to reduce resource consumption. As shown, recommendations 310 includes three suggested steps that a consumer can take to reduce resource consumption as well as a detailed description as to why performing the recommendation helps reduce resource consumption.

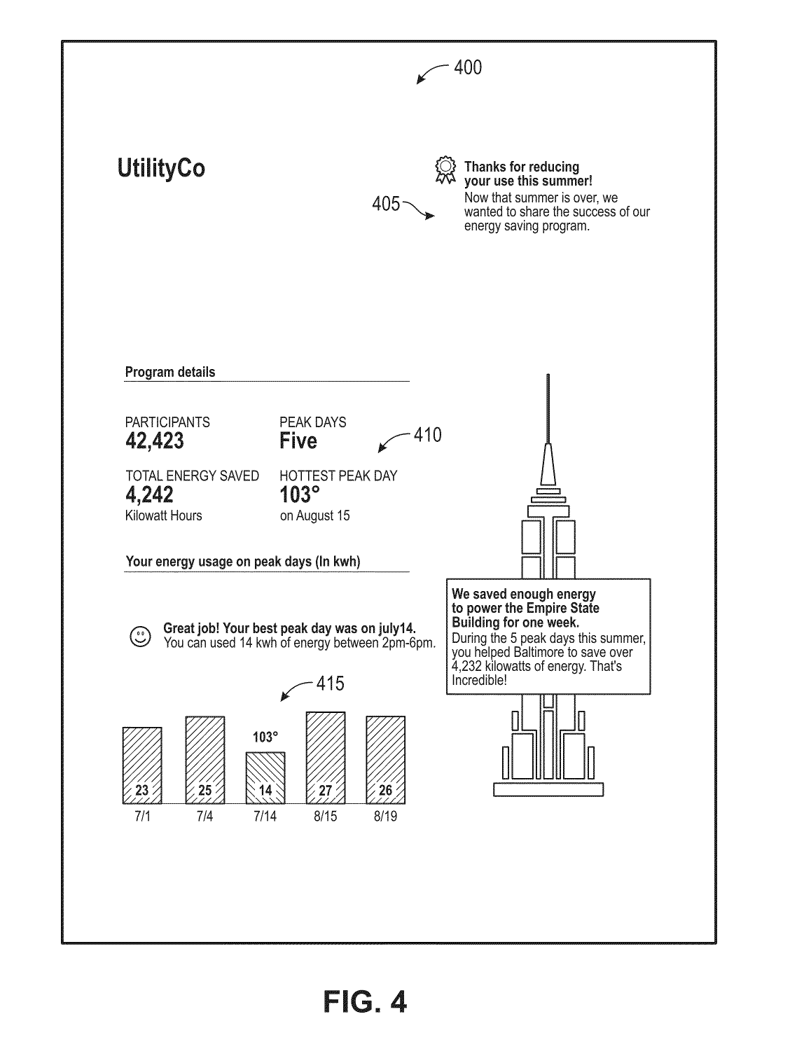

FIG. 4 illustrates another example resource consumption report 400. As shown, resource consumption report 400 can include message 405 thanking the consumer for participating in the resource reduction program. Further, resource consumption report 400 can include resource consumption data 410 that detail resource consumption by a population of consumers over multiple peak events. In the illustrated example, resource consumption data 410 details resource consumption data gathered from 42,423 consumers over five peak days and includes the amount of overall resources saved to highlight the impact of the BDM campaign.

Resource consumption report 400 can also include resource consumption data 415 that details individual consumer resource consumption during peak events. This can provide the consumer with a snapshot of their individual performance and progress in addition to the big picture performance provided by resource consumption data 410.

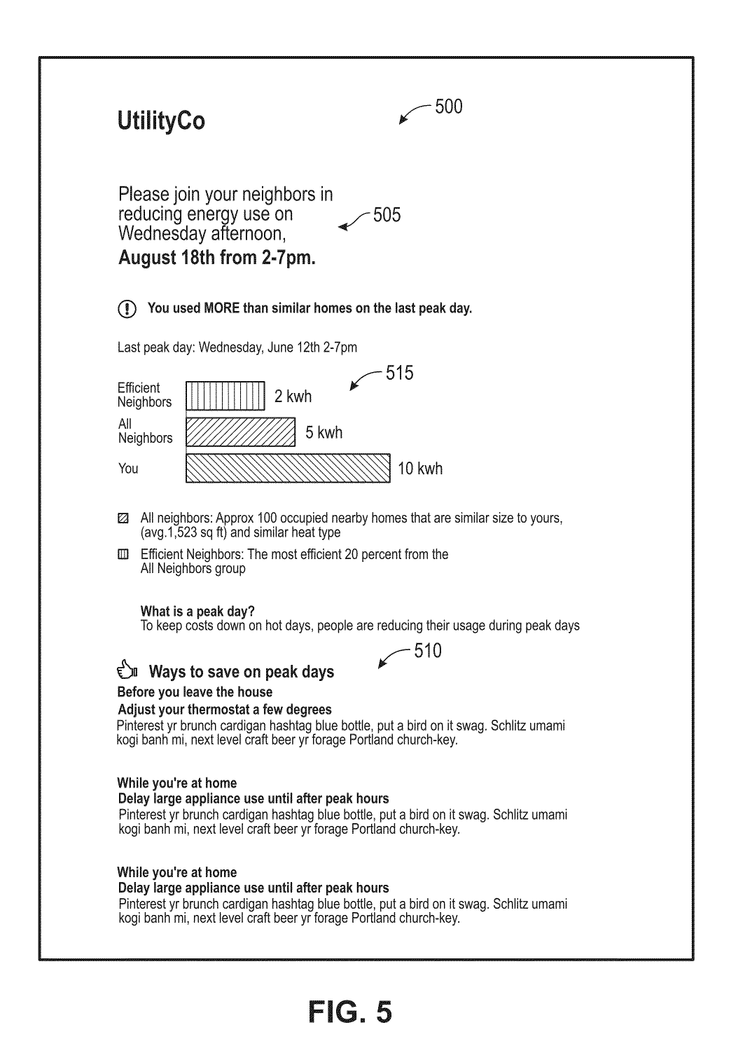

FIG. 5 illustrates an exemplary resource consumption report 500 that notifies a consumer of an upcoming peak event. As shown, resource consumption report 500 includes peak event notification 505 that details an upcoming peak event by including the date and time of the predicted or scheduled peak event. Further, peak event notification 505 requests that the consumer reduce resource consumption during the upcoming peak event.

This request is bolstered by recommendations 510 that detail recommended ways for the consumer to reduce resource consumption during the upcoming peak event. As shown, recommendations 510 includes three suggested steps that a consumer can take to reduce resource consumption as well as a detailed description as to why performing the recommendation helps improve conservation.

Resource consumption report 500 can also include resource consumption data 515 that details the specific consumer's resource consumption. As shown, resource consumption data 515 details the consumer's resource consumption during a previous peak event (e.g., the most recent peak event). Further, resource consumption data 515 includes a comparison of the consumer's resource consumption to the resource consumption of all other neighbors and the most efficient neighbors during the same peak event.

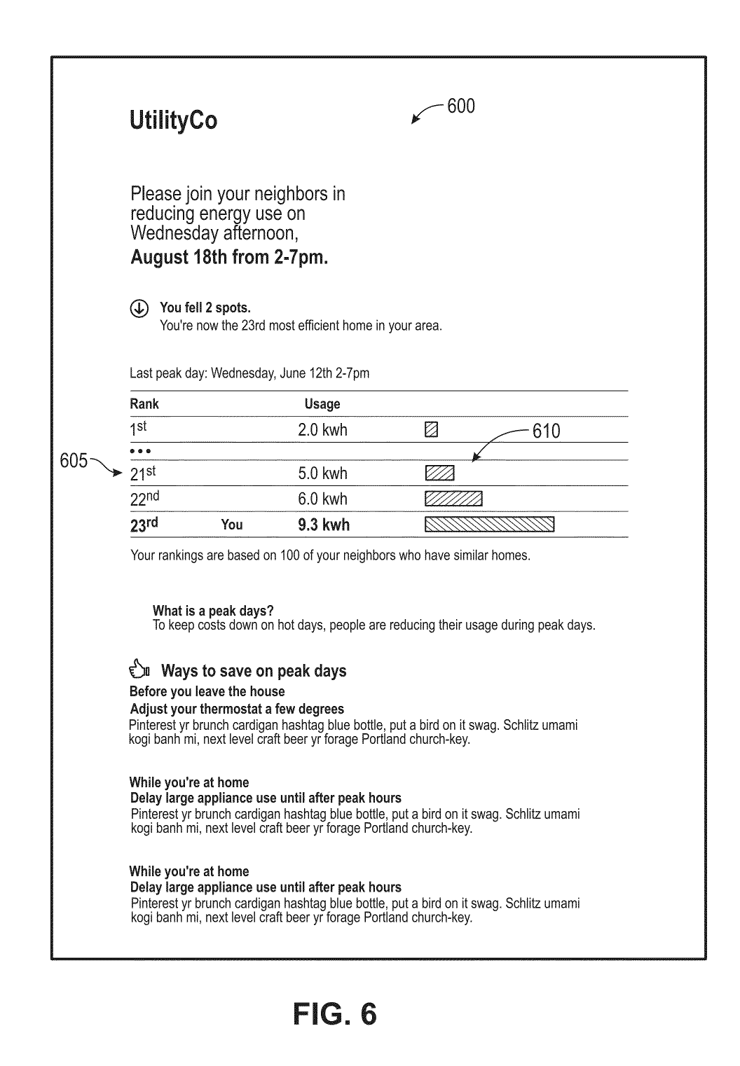

FIG. 6 illustrates an example resource consumption report 600 that includes ranking data. As shown, resource consumption report 600 includes ranking data 605 that details a consumer's resource consumption versus that of other users/consumers. In addition to illustrating the consumer's rank amongst the other consumers, consumption report 600 can include resource consumption data 610 indicating the resource consumption of each ranked consumer. As shown, the resource consumption data 610 details the resource consumption of each consumer by listing the amount of resources consumed by each consumer as well as by presenting a bar representing the resource consumption of each consumer.

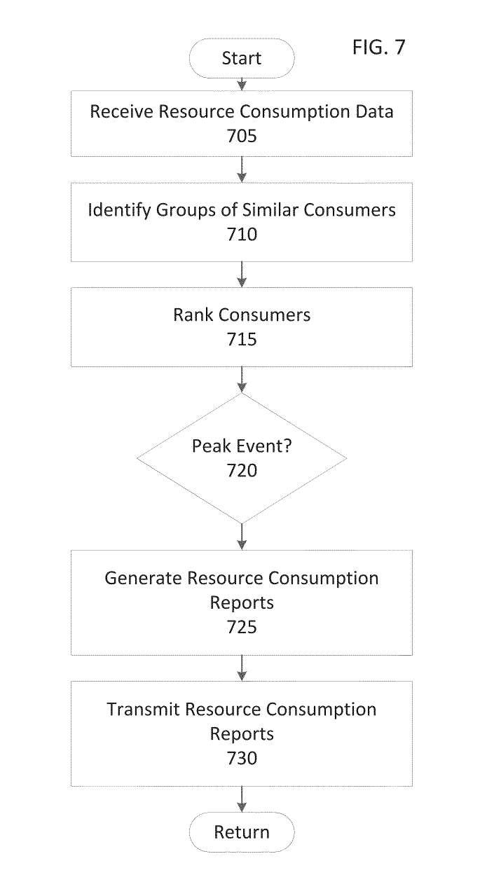

FIG. 7 illustrates an exemplary method embodiment of implementing a BDM program to reduce resource consumption. As shown, the method begins at block 705 where resource consumption data is received. Resource consumption data can be data describing resource consumption by one or more consumers. Further, resource consumption data can include data describing the resource consumption, such as the time the resources were consumed, identifying information pertaining to the consumer that consumed the resource/s, etc.

At block 710, groups of similar consumers are identified. Consumers can be determined to be similar based on numerous factors such as geographic location, location type, base line resource consumption, consumer size, or demographic information, etc. For example, consumers that have a geographic location that is within a predetermined distance of each other can be determined to be similar. Likewise, consumers that have a base line resource consumption that is within a predetermined range can be determined to be similar.

Consumer size can refer to the number of people of the consumer, such as the number of members of a family or employees of a company, or alternatively, the size of a building or dwelling associated with the consumer, such as the size of the consumer's house or office building. Consumers that have a consumer size that is within a predetermined range or within a predetermined range of each other can be determined to be similar.

Consumers can also be determined to be similar based on any other demographic data. Consumers that share specified demographic data and/or have demographic data that is within a specified range or specified range of each other can be determined to be similar.

At block 715, the consumers are ranked based on one or more factors. For example, consumers can be ranked based on resource consumption, improvement in reducing resource consumption from a previous time period, reducing resource consumption in relation to the specified consumer's base line resource consumption, etc. The consumers can be ranked as a whole or, alternatively, amongst subsets of the entire group of consumers. For example, consumers can be ranked amongst a group of similar consumers, consumers within a specified geographic location, etc.

At block 720, it is determined whether a peak event is predicted or scheduled. A peak event can be a predicted time period in which resource consumption is predicted to spike, perhaps to levels above resource capacity. A peak event can be predicted in numerous ways. For example, recurring peak events may be known from previous history. Alternatively, in some embodiments, peak events can be predicted based on analyzing resource consumption data and/or non-resource consumption data to identify patterns and/or factors that indicate that a peak event is likely. This can include trends in resource consumption, weather forecast's, and/or behavior models of individual/group user behavior, etc.

If at block 720 it is determined that a peak event is upcoming, the method continues to block 725 where resource consumption reports can be generated. A resource consumption report can be a message that includes resource consumption data and encourages consumers to reduce resource consumption. The generated resource consumption reports can include details to notify the consumers about the predicted peak event and also a message requesting that the consumers reduce their resource consumption during the peak event.

The resource consumption report can also include resource consumption data detailing the resource consumption of the individual consumer and/or a group of consumers. This can include details regarding resource consumption as well reduction in resource consumption by the individual consumer and/or a group of consumers. Further the resource consumption report can include ranking data for consumer.

The resource consumption report can also include suggestions on how the consumer can reduce resource consumption.

At block 730, the generated resource consumption reports can be transmitted to the appropriate consumers. The resource consumption reports can be transmitted using one or more channels such as e-mail, text message, instant message, etc. In some embodiments, a resource consumption report can be transmitted to a consumer using a preferred communication channel selected by the consumer.

FIG. 8A, and FIG. 8B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM/storage 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
receiving, by a computer processor, resource consumption data for a plurality of consumers;
upon a determination that a geographic location of a first consumer of the plurality of consumers is within a predetermined distance of a geographic location of a second consumer of the plurality of consumers, assigning, by the computer processor, the first consumer and the second consumer to a first group of similar consumers; and
ranking, by the computer processor, consumers assigned to the first group of similar consumers based on their respective resource consumption data.

2. The method of claim 1, further comprising:
generating a resource consumption report that includes data regarding the first consumer's ranking amongst the first group of similar consumers; and
transmitting, to the first consumer, the resource consumption report.

3. The method of claim 1, further comprising:
determining that a dwelling size of a third consumer of the plurality of consumers is within a predetermined range of a dwelling type of a fourth consumer of the plurality of consumers;
assigning the third consumer and the fourth consumer to a second group of similar consumers; and
ranking consumers assigned to the second group of similar consumers based on their respective resource consumption data.

4. The method of claim 1, wherein the ranking consumers assigned to the first group of similar consumers further comprises:
comparing a resource consumption of the first consumer to a resource consumption of the second consumer;
determining that the resource consumption of the first consumer is less than the resource consumption of the second consumer,
assigning, a first rank to the first consumer and a second rank, different than the first rank, to the second consumer, wherein the first rank is greater than the second rank.

5. The method of claim 1, wherein the ranking consumers assigned to the first group of similar consumers further comprises:
comparing a reduction in resource consumption of the first consumer from resource consumption during a past peak event to a reduction in resource consumption of the second consumer from resource consumption during the past peak event, wherein the reduction in resource reduction of the first consumer is measured from a base line resource consumption of the first consumer, and the reduction in resource consumption of the second consumer is measured from a base line resource consumption of the second consumer,
determining that the reduction in resource consumption of the first consumer is greater than the reduction in resource consumption of the second consumer; and
assigning a first rank to the first consumer and a second rank, different than the first rank, to the second consumer, wherein the first rank is greater than the second rank.

6. The method of claim 1, further comprising:
determining that a peak event will occur at a predicted time;
generating a resource consumption report that includes data regarding the peak event and a message encouraging consumers to reduce consumption during the peak event; and
prior to the predicted time, transmitting the resource consumption report to at least one consumer assigned to the first group of similar consumers.

7. The method of claim 6, wherein determining that the peak event will occur at a predicted time further comprises:
analyzing weather forecast data indicating predicted temperatures for the geographic location of the first consumer; and
determining, from the analyzing, that a predicted temperature for the predicted time exceeds a predetermined threshold value indicating that resource consumption will increase during the predicted time.

8. A system comprising:
a computer processor; and
a memory storing instructions that, when executed, cause the computer processor to:
receive resource consumption data for a plurality of consumers;
assign a subset of similar consumers from the plurality of consumers to a first group of similar consumers;
generate a resource consumption report for a first consumer based on the resource consumption data, wherein the resource consumption report includes comparative data comparing resource consumption of the first user to resource consumption of at least a second consumer assigned to the first group of similar consumers.

9. The system of claim 8, wherein the comparative data includes a resource consumption of the first consumer during a first time period and a resource consumption of the second consumer during the second time period.

10. The system of claim 9, wherein the comparative data includes a first bar chart indicating the resource consumption of the first consumer during a first time period and a second bar chart indicating the resource consumption of the second consumer during a first time period.

11. The system of claim 8, wherein the instructions further cause the computer processor to:
rank consumers assigned to the first group of similar consumers based on their respective resource consumption data, wherein the comparative data includes a ranking for the first consumer amongst the consumers assigned to the first group of similar consumers.

12. The system of claim 11, wherein the instructions further cause the computer processor to:
determine a change in rank for the first consumer from a previous rank of the first consumer, wherein the comparative data includes the change in rank.

13. The system of claim 8, wherein the instructions further cause the processor to:
rank the plurality of consumers based on their respective resource consumption data, wherein the comparative data includes a rank of the first user amongst the plurality of consumers.

14. The system of claim 8, wherein the instructions further cause the processor to:
identify a top performing subset of consumers assigned to the first group of similar consumers that had a resource consumption below a specified threshold value; and
calculate an average resource consumption of the top performing subset of consumers assigned to the first group of similar consumers, wherein the comparative data includes the average resource consumption of the top performing subset of consumers.

15. A non-transitory computer-readable medium storing instructions that, when executed by a computer processor, cause the computer processor to:
receive resource consumption data for a plurality of consumers;
determine that a first consumer of the plurality of consumers shares a demographic criteria with a second consumer of the plurality of consumers;
assign the first consumer and the second consumer to a first group of similar consumers; and
rank consumers assigned to the first group of similar consumers based on their respective resource consumption data.

16. The non-transitory computer-readable medium of claim 15, wherein the determining that the first consumer shares a demographic criteria with the second consumer comprises:
comparing a geographic location associated with the first consumer to a geographic location associated with the second consumer; and
determining that the geographic location associated with the first consumer is within a predetermined distance of the geographic location associated with the second consumer.

17. The non-transitory computer-readable medium of claim 15, wherein the determining that the first consumer shares a demographic criteria with the second consumer comprises:
comparing an average resource consumption of the first consumer to an average resource consumption of the second consumer, and
determining that the average resource consumption of the first consumer is within a predetermined range of the average resource consumption of the second consumer.

18. The non-transitory computer-readable medium of claim 15, wherein the determining that the first consumer shares a demographic criteria with the second consumer comprises:
comparing an income of the first consumer to an income of the second consumer; and
determining that the income of the first consumer is within a predetermined range of the income of the second consumer.

19. The non-transitory computer-readable medium of claim 15, wherein the determining that the first consumer shares a demographic criteria with the second consumer comprises:
comparing dwelling size of the first consumer to a dwelling size of the second consumer, and
determining that the swelling size of the first consumer is within a predetermined range of the average dwelling size of the second consumer.

20. The non-transitory computer-readable medium of claim 15, wherein the instructions further cause the computer processor to:
generate a resource consumption report that includes data regarding the first consumer's ranking amongst the first group of similar consumers; and
transmit, to the first consumer, the resource consumption report.
